(19) United States
(12) Patent Application Publication
(10) Pub. No.: US 2020/0290620 A1
(43) Pub. Date: Sep. 17, 2020

(54) METHOD AND APPARATUS FOR HIGH DEFINITION MAP BASED VEHICLE CONTROL FOR ASSISTED DRIVING

(71) Applicant: GM GLOBAL TECHNOLOGY OPERATIONS LLC, Detroit, MI (US)

(72) Inventors: Mohammed H. Al Qizwini, Macomb, MI (US); Xuewei Qi, Sterling Heights, MI (US); Joon Hwang, Pflugerville, TX (US); David H. Clifford, Royal Oak, MI (US)

(73) Assignee: GM GLOBAL TECHNOLOGY OPERATIONS LLC, Detroit, MI (US)

(21) Appl. No.: 16/355,079

(22) Filed: Mar. 15, 2019

(51) Int. Cl. B60W 30/18; G06F 16/29; B60W 30/16; B60W 30/12; B60W 50/00

(52) U.S. Cl. CPC B60W 30/18163; G06F 16/29; B60W 30/16; B60W 30/12; B60W 2550/302; B60W 2550/306; B60W 2420/52; B60W 2050/0089; B60W 2420/42; B60W 50/00

(57) ABSTRACT

The present application generally relates to a method and apparatus for generating an action policy for controlling an autonomous vehicle. In particular, the method and apparatus are operative for determining a following distance between a host vehicle and a lead vehicle and a lead vehicle speed, generating a lane change request in response to the following distance, a host vehicle speed and the lead vehicle speed, determining an available lane in response to an image and the lane change request, generating a lane change command in response to the available lane, generating a control signal in response to the lane change request and a map data and controlling the vehicle to execute a lane change action in response to the control signal.

### BACKGROUND

The present disclosure relates generally to programming autonomous motor vehicle control systems. More specifically, aspects of this disclosure relate to systems, methods and devices for behavior planning using high definition map and radar sensor data for longitudinal and latitudinal control for autonomous vehicles in a complicated environment.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Appropriate situation awareness is essential for autonomous driving due to safety concerns. Even though it is desirable to put all available information into autonomous driving decision process; however, for practical implementation, input data to the system should be limited and manageable; therefore the decision process needs to be well-designed for both efficiency and sufficiency for decision making. An autonomous vehicle generally must generate a data structure to perceive situations around the vehicle. Through sensors mounted on the autonomous driving vehicle, a huge amount of information is delivered to the system; therefore, efficient analysis of all perception data for safe driving is crucial.

Typically, in an assisted driving control system, all available data is collected and combined in a three dimensional map, trajectory data about surrounding objects is calculated, the future locations of the objects are predicted, and a safe path for the controlled vehicle is estimated. All of this computation is processor intensive and requires excessive time and power which limits the performance of an assisted driving vehicle. It would be desirable to provide a realistic and light assisted driving control system for reinforced learning based active training for autonomous vehicle longitudinal and lateral control with reduced sensor data.

The above information disclosed in this background section is only for enhancement of understanding of the background of the invention and therefore it may contain information that does not form the prior art that is already known in this country to a person of ordinary skill in the art.

### SUMMARY

Disclosed herein are autonomous vehicle control system training systems and related control logic for provisioning autonomous vehicle control, methods for making and methods for operating such systems, and motor vehicles equipped with onboard control systems. By way of example, and not limitation, there is presented an automobile with onboard vehicle control learning and control systems.

In accordance with an aspect of the present invention, a method for controlling a vehicle comprising determining a following distance between a host vehicle and a lead vehicle and a lead vehicle speed, generating a lane change request in response to the following distance, a host vehicle speed and the lead vehicle speed, determining an available lane in response to an image and the lane change request, generating a lane change command in response to the available lane, and generating a control signal in response to the lane change request and a map data, and controlling the vehicle to execute a lane change action in response to the control signal.

In accordance with another aspect of the present invention wherein the control signal is further generated in response to a global positioning system data.

In accordance with another aspect of the present invention wherein the host vehicle speed is reduced in response to the available lane indicating that a lane is not available.

In accordance with another aspect of the present invention wherein the following distance is determined in response to a radar signal.

In accordance with another aspect of the present invention wherein the image is generated by a side view camera mounted on the host vehicle.

In accordance with another aspect of the present invention wherein the control signal is generated in response to a lane change action episode and the map data.

In accordance with another aspect of the present invention further comprising updating a lane change episode in response to the control.

In accordance with another aspect of the present invention an apparatus comprising a first processor for calculating a following distance in response to a radar data file and for generating a change lane request in response to the following distance being less than a threshold value, a second processor for receiving the change lane request and for determining a lane availability in response to an image and the change lane request and for generating a lane change control signal in response to the lane availability, a third processor for calculating a lane change route in response to a map data, and the lane change control signal, a memory for storing an episode generated in response to the radar data, the lane change request, the lane availability compiler and the lane change route, and a vehicle controller executing a lane change in response to the episode.

In accordance with another aspect of the present invention wherein the first processor is a longitudinal processor for maintaining the following distance in an adaptive cruise control system.

In accordance with another aspect of the present invention wherein the second processor is a latitudinal processor for performing a lane centering operation in an adaptive cruise control system.

In accordance with another aspect of the present invention wherein the third processor is a lane change processor for performing the lane change in an adaptive cruise control system.

In accordance with another aspect of the present invention wherein the radar data file is generated in response to a vehicular adaptive cruise control data log.

In accordance with another aspect of the present invention wherein the lane change is executed before the following distance reaches a minimum value.

In accordance with another aspect of the present invention wherein the episode is generated in response to multiple lane change actions.

In accordance with another aspect of the present invention a vehicular control system comprising a memory for storing a lane change episode and a map data, a radar sensor for detecting a distance to a lead vehicle, a first processor for generating a lane change request in response to the distance, a camera for generating an image of an adjacent lane, a second processor for determining a lane availability in response to the image and for generating a lane change command in response to the lane availability, a third processor for determining a lane change route in response to the lane change command, the episode, the map data and for generating a lane change control signal in response to the lane change route, and a vehicle controller for executing the lane change in response to the lane change control signal.

In accordance with another aspect of the present invention wherein the first processor is a longitudinal processor for maintaining the following distance in an adaptive cruise control system.

In accordance with another aspect of the present invention wherein the second processor is a latitudinal processor for performing a lane centering operation in an adaptive cruise control system.

In accordance with another aspect of the present invention wherein the third processor is a lane change processor for controlling the lane change in an adaptive cruise control system.

In accordance with another aspect of the present invention wherein the vehicular control system is operative to perform an adaptive cruise control function in an assisted driving equipped vehicle.

In accordance with another aspect of the present invention wherein the third processor is further operative to update the episode according to a reinforced learning algorithm.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 shows an operating environment that comprises a mobile vehicle communication and control system for a motor vehicle according to an exemplary embodiment.

FIG. 2 shows a block diagram illustrating a system for high definition map based vehicle control for assisted driving according to an exemplary embodiment.

FIG. 3 shows a flow chart illustrating a method for high definition map based vehicle control system training for assisted driving according to another exemplary embodiment.

FIG. 4 shows a block diagram illustrating an exemplary implementation of a system for high definition map based vehicle control for assisted driving in a vehicle.

FIG. 5 shows a flow chart illustrating a method for high definition map based vehicle control for assisted driving according to another exemplary embodiment

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

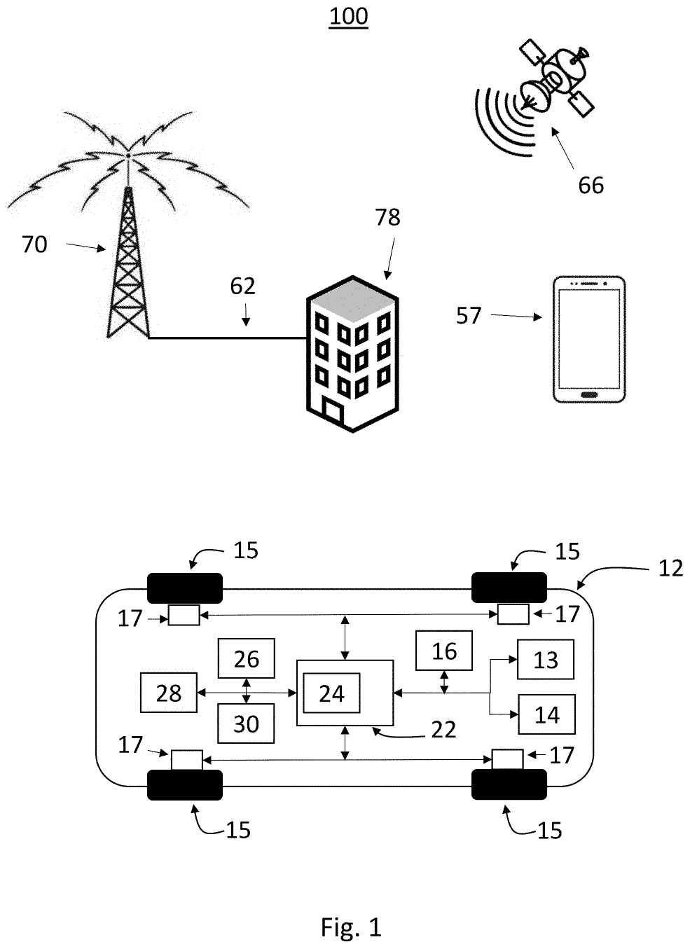

FIG. 1 schematically illustrates an operating environment that comprises a mobile vehicle communication and control system 100 for a motor vehicle 12. The communication and control system 10 for the vehicle 12 generally includes one or more wireless carrier systems 60, a land communications network 62, a computer 64, a networked wireless device 57 including but not limited to a smart phone, tablet, or wearable device such as a watch, and a remote access center 78.

The vehicle 12, shown schematically in FIG. 1, includes a propulsion system 13, which may in various embodiments include an internal combustion engine, an electric machine such as a traction motor, and/or a fuel cell propulsion system. Vehicle 12 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor such as a central processing unit (CPU) or graphics processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the networked wireless device 57. The networked wireless device 57 can include computer processing capability, a transceiver capable of communicating using a short-range wireless protocol, and a visual display. The computer processing capability includes a microprocessor in the form of a programmable device that includes one or more instructions stored in an internal memory structure and applied to receive binary input to create binary output. In some embodiments, the networked wireless device 57 includes a GPS module capable of receiving GPS satellite signals and generating GPS coordinates based on those signals. In other embodiments, the networked wireless device 57 includes cellular communications functionality such that the networked wireless device 57 carries out voice and/or data communications over a wireless carrier system using one or more cellular communications protocols, as are discussed herein. The visual display may also include a touch-screen graphical user interface.

The wireless carrier system is preferably a cellular telephone system that includes a plurality of cell towers 70 (only one shown), one or more mobile switching centers (MSCs), as well as any other networking components required to connect the wireless carrier system with the land communications network 62. Each cell tower 70 may include sending and receiving antennas and a base station, with the base stations from different cell towers being connected to the MSC either directly or via intermediary equipment such as a base station controller. The wireless carrier system can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system, a second wireless carrier system in the form of satellite communication can be used to provide uni-directional or bi-directional communication with the vehicle 12. This can be done using one or more communication satellites 66 and an uplink transmitting station coupled to the communications network 62. Uni-directional communication can include, for example, satellite radio services, wherein programming content (news, music, etc.) is received by the transmitting station, packaged for upload, and then sent to the satellite 66, which broadcasts the programming to subscribers. Bi-directional communication can include, for example, satellite telephony services using the satellite 66 to relay telephone communications between the vehicle 12 and the communications network 62. The satellite telephony can be utilized either in addition to or in lieu of the wireless carrier system 60.

The communications network 62 may be a conventional land-based telecommunications network connected to one or more landline telephones and connects the wireless carrier system 60 to the remote access center 78. For example, the communications network 62 may include a public switched telephone network (PSTN) such as that used to provide hardwired telephony, packet-switched data communications, and the Internet infrastructure. One or more segments of the communications network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network, but could include wireless telephony equipment so that it can communicate directly with a wireless network, such as a wireless carrier system.

The remote access center 78 is designed to provide the wireless communications system 28 of the vehicle 12 with a number of different system functions and, according to the exemplary embodiment shown in FIG. 1, generally includes one or more switches, servers, databases, live advisors, as well as an automated voice response system (VRS). These various remote access center components are preferably coupled to one another via a wired or wireless local area network. The switch, which can be a private branch exchange (PBX) switch, routes incoming signals so that voice transmissions are usually sent to either the live adviser by regular phone or to the automated voice response system using VoIP. The live advisor phone can also use VoIP as indicated by the broken line in FIG. 1. VoIP and other data communication through the switch is implemented via a modem (not shown) connected between the switch and the network. Data transmissions are passed via the modem to the server and/or the database. The database can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned remote access center using the live advisor, it will be appreciated that the remote access center can instead utilize the VRS as an automated advisor, or a combination of the VRS and the live advisor can be used.

The disclosed methods can be used with any number of different systems and is not specifically limited to the operating environment shown here. The architecture, construction, setup, and operation of the system 100 and its individual components is generally known. Other systems not shown here could employ the disclosed methods as well.

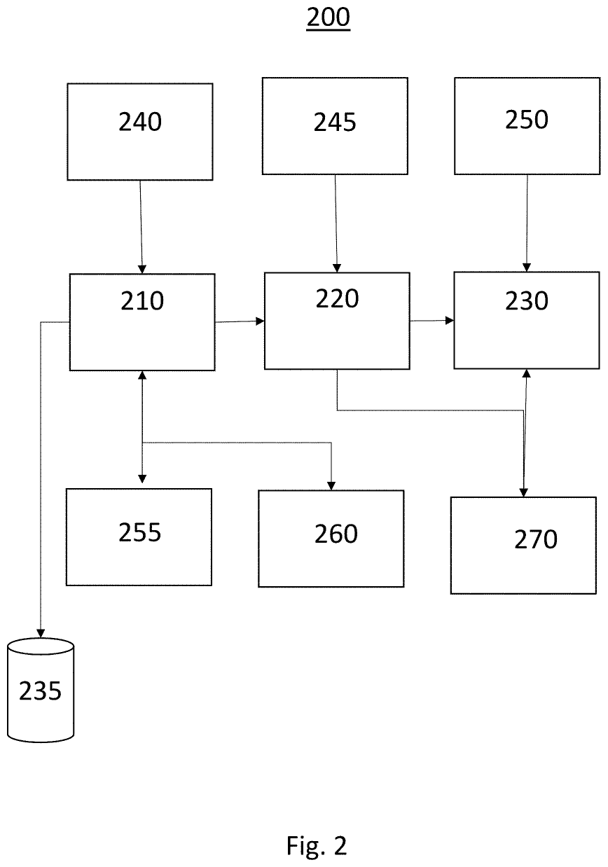

Turning now to FIG. 2, a block diagram illustrating an exemplary implementation of a system for high definition map based vehicle control for assisted driving 200 is shown. The exemplary system 200 is operative to generate control data for vehicular assisted driving systems. The exemplary system 200 is operative to use reinforcement learning (RL) to generate a control algorithm for autonomous vehicle control by applying reinforcement learning (RL) methods to train a control algorithm that can autonomously learn how to perform lane change actions using a reduced amount of input data. Unlike rule-based algorithms, RL algorithms can learn to deal with unpredictable and changeable situations based on errors and trials during the training process. Unlike supervised learning, RL does not need a large amount of labeled data to train a data-based model. The exemplary system 200 is operative to develop a flexible mapping function from environment states to agent actions according to recorded experience, similar to how human drivers learn to drive.

Previously, RL methods encounter difficulty with high-dimensional state space problems such as autonomous vehicle decision-making in complicated urban environments. To overcome this problem, previous RL algorithms required a long training period to get an acceptable result. For difficult problems with high-dimensional state spaces, these algorithms could not guarantee convergence of the loss function and satisfactory performance during a limited training period.

The current system addresses these problems by receiving data indicative of a radar data collected by a radar sensor 240 by an assisted driving vehicle. The radar data may be collected and stored by an assisted driving or autonomous driving vehicle. Alternatively, the radar data may be simulated by a simulation algorithm or manually generated. In this exemplary embodiment, the radar data may be stored in a format similar to data received from a radar sensor 240. In addition, in this exemplary embodiment illustrating a system operative to perform a simulation of a lane change operation, the radar sensor 240 may be a memory for storing the radar data. The radar data may then be coupled to a longitudinal processor 210.

The longitudinal processor 210 is operative to receive the radar data indicative of radar data collected by a radar sensor 240 and to simulate an adaptive cruise control operation. For example, the radar data may indicate that a lead vehicle is located 50 meters ahead of the host vehicle in the same driving lane. The lead vehicle may be traveling at a simulated rate of 55 miles per hour and the host vehicle may be traveling at a simulated rate of 60 miles per hour. The adaptive cruise control simulation may have an exemplary following distance set at 30 meters. After a certain elapsed time, the longitudinal processor may determine that a reduction in speed or a lane change is required when the following distance approaches 30 meters. At this point, the longitudinal processor 210 may generate a lane change request control signal and couple this lane change request control signal to a latitudinal processor 220 requesting a lane change.

The latitudinal processor 220 is operative to receive the lane change request from the longitudinal processor 210. The latitudinal processor 220 is then operative to request data indicative of simulated vehicles traveling in a lane to the left of the host vehicle. This data may be supplied by the radar sensor 240, a simulated camera sensor 245 or other source of simulated data. The latitudinal processor 220 is then operative to determine if there is sufficient room in the adjacent target lane for the host vehicle to safely execute a lane change operation. For example, the latitudinal processor 220 may determine if there is a simulated vehicle is within 30 meters behind or ahead of the host vehicle in the adjacent target lane, indicative of a safe area. In no vehicle is detected within the safe area, the latitudinal processor 220 may couple a signal to a lane change processor 230 indicating a request for a lane change to the left of the host vehicle. If the latitudinal processor 220 determines the presence of a vehicle within the safe area of the left lane, the latitudinal processor 220 then similarly checks the right lane. If no vehicle is detected within the safe area, the latitudinal processor 220 may couple a signal to a lane change processor 230 indicating a request for a lane change to the right of the host vehicle. If the latitudinal processor 220 determines the presence of a vehicle within the safe area of the right lane, the latitudinal processor 220 then may couple a control signal back to the longitudinal processor 210 indicating that no lane change is possible. The longitudinal processor 210 may then be operative to reduce the speed of the host vehicle to maintain the following distance from the lead vehicle by generating a control signal for coupling to a throttle controller 255. The longitudinal processor 210 may further be operative to execute a control signal to couple to a braking controller 260 in order to reduce the speed of the host vehicle.

The lane change processor 230 is operative to receive map data from a map data source 250, such as a memory or a network, and to execute a lane change operation in response to the request from the latitudinal processor 220. For example, the lane change processor 230 may be operative to determine an optimal lane change route between a closest middle point in the current lane and a target point on the adjacent target lane and to generate a control signal coupled to a vehicle steering controller 270 such that the lane change is executed in a desired time duration. For example, if it is desirable that a lane change be executed in three seconds, the lane change processor will determine a lane change route that is three second long. Then the target point is approached, the lane change processor 230 is then operative to couple a control signal back to the latitudinal processor 220 which is then operative to center the host vehicle on the new lane. Once the host vehicle is centered on the new lane, the latitudinal processor 220 may then generate a control signal to indicate to the longitudinal processor 210 that the host vehicle is centered in the new lane at that a reduction is speed may not be required in view of the lead vehicle.

The system further comprises a memory 235 for storing an episode generated in response to a combination of at least two of the radar data, the lane change request, the available lane determination and the optimal lane change route. The episode is then used to control an assisted driving vehicle.

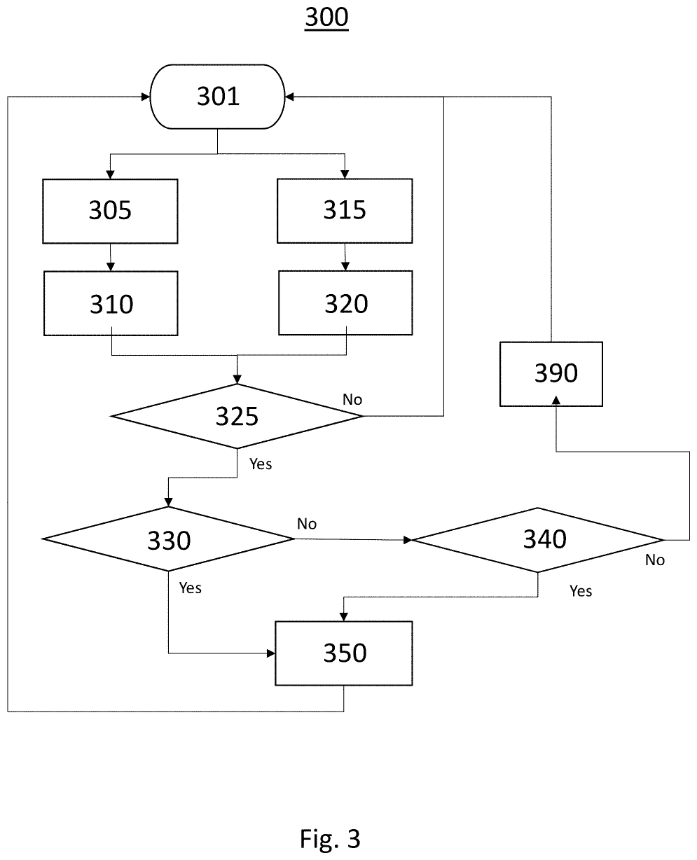

Turning now to FIG. 3, a flow chart illustrating an exemplary implementation of a method for high definition map based vehicle control system training for assisted driving 300 is shown. The method is operative to perform a training iteration for a reinforced learning algorithm for generating a control system for an assisted driving vehicle. In this exemplary method, the host vehicle, lead vehicle and proximate vehicles may be computer generated in order to train the reinforced learning algorithm. The method is first operative to start the training iteration 301. The method then retrieves the data representative of radar signal 305 at a first time step and simulates a longitudinal assisted driving action 310, determining a distance to a lead vehicle in the lane in front of the host vehicle. The method is operative to calculate a distance to the lead vehicle and a speed or velocity of the lead vehicle. The method the determines if a lane change is to be made in response to the velocity and distance to the lead vehicle. If the distance is less than a predetermined following distance, or the host vehicle is traveling faster than the lead vehicle and the distance is nearing the following distance, the method is then operative to determine that a lane change is desired 325.

Simultaneous with the longitudinal assisted driving action 310, the method is operative to retrieve data 315 to be used perform a latitudinal assisted driving action 320. This data may include image data, radar data, or the like, of the areas proximate to the host vehicle. The latitudinal assisted driving action 320 may include a lane keep action wherein the latitudinal assisted driving action 320 is operative to keep the host vehicle centered in the current lane. The latitudinal assisted driving action 320 may perform this action in response to a left lane marker, a right lane marker, both lane markers, map data, GPS information or the like. The method is then operative to determine if the desire for a lane change 325 has been determined by the longitudinal assisted driving action. If no lane change has been desired 325 the method is then operative to return to the start of the method 301.

If a lane change is desired 325, the method is operative to first determine if there is an available space in the lane to the left of the current lane 330. In this exemplary embodiment, a lane may be determined to be clear and safe for a lane change action if there are no vehicles within 30 meters ahead of or behind the host vehicle. The 30 meter safe distance may be determines in response to engineering design specifications and is not limiting to the presently disclosed method and systems. The safe distance may be any distance and may vary based on host vehicle speed, adjacent vehicle speeds, traffic density, geographical location or the like. If the left lane is determined to be clear 330, a lane change is requested from a lane change algorithm. If the left lane is not clear, the method is then operative to check if there is an available space in the lane to the right of the current lane 340. Similarly as described with respect to the left lane, if the lane is clear a lane change is requested from a lane change algorithm. If the right lane is not clear, the method is operative to generate a request for reduced speed which is coupled to the longitudinal assisted driving action 310. The method is then operative to return to the start of the method 301 with the longitudinal driving action speed set to the reduced speed in response to the speed of the lead vehicle and the predetermined following distance.

If it is determined that a target lane is clear, either the left or right lane, the method is then operative to engage a lane change algorithm for performing the lane change 350. The lane change algorithm is then operative to request or retrieve map data 355. In addition, the lane change algorithm may determine a GPS location of the host vehicle. The map data may indicate the lane locations. The lane change algorithm is then operative to determine an optimal lane change path 360 in response to the closest middle point on the current lane, a target point on the center of the desired lane, and the target time for making the lane change. The target time may be determined in response to the speed of the host vehicle, proximate vehicles, geographical location, etc. In this exemplary embodiment, the target time for the lane change may be three seconds. Once the optimal lane change path is determined, a control signal indicative of the lane change path is coupled to a simulated vehicle controller 365 for simulating the lane change. The results of the lane change action are stored to an assisted driving control algorithm, and a score determined in response to a reward policy for the action. The method is then operative to return to the start of the method 301. The assisted driving control algorithm may then be coupled to an assisted driving control algorithm in a vehicle for use in controlling the vehicle in response to an actual driving environment.

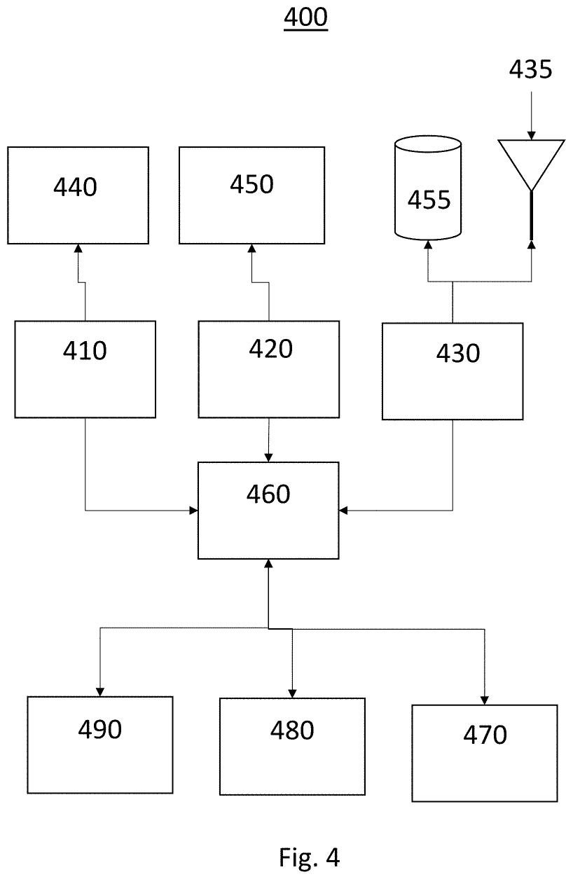

Turning now to FIG. 4, a block diagram illustrating an exemplary implementation of a system for high definition map based vehicle control for assisted driving 400 in a vehicle is shown. The system 400 is implemented in a host vehicle, and includes an antenna 435, a radar 440, a camera 450, a memory 455, a longitudinal controller 410, a latitudinal controller 420, a lane change controller 430, a vehicle controller 460, a steering mechanism 490, a throttle mechanism 480 and a braking mechanism 470.

In this exemplary embodiment, the longitudinal controller 410 is operative to perform the functions associated with adaptive cruise control for a vehicle. The longitudinal controller 410 is first operative to receive a user input indicative of a desired speed of the host vehicle. For example, the user input may be indicative of a desired speed of seventy miles per hour. The longitudinal controller 410 is further operative to receive data from the radar 240 indicative of a distance to a lead vehicle driving in the lane ahead of the host vehicle. Over time, the longitudinal controller 410 calculates the speed of the lead vehicle and compares the lead vehicle speed to the speed of the host vehicle. The longitudinal controller 410 may determine as a result of the comparison that the following distance will be less than a threshold distance and therefore a lane change or a reduction of speed for the host vehicle is required. The longitudinal controller 410 may then request a lane change from the latitudinal controller 420.

In response to a lane change request from the longitudinal controller 410, the latitudinal controller 420 may first determine if the next leftmost lane is a valid lane change destination. In this exemplary embodiment, the latitudinal controller 420 is operative to receive data from the camera 450 facing the left lane and to determine if a proximate vehicle is within a safe lane change distance, such as 30 meters, of the host vehicle. If no proximate vehicle is within the safe lane change distance, the latitudinal controller 420 is operative to send a control signal to the lane change controller 430 requesting a lane change to the next leftmost lane. If a proximate vehicle is within the left lane, the latitudinal controller 420 repeats the operation with respect to the right lane. The latitudinal controller 420 is again operative to receive data from the camera 450 and to determine if a proximate vehicle is within a safe lane change distance in the next rightmost lane. If no proximate vehicle is within the safe lane change distance in the next rightmost lane, the latitudinal controller 420 sends a control signal to the lane change controller 430 requesting a lane change to the next rightmost lane. If a proximate vehicle is within the safe lane change distance in the next rightmost lane, the latitudinal controller 420 is operative to send a control signal back to the longitudinal controller 410 indicating that a lane change is not possible.

If the longitudinal controller 410 receives a control signal from the latitudinal controller 420 that a lane change is not possible, the latitudinal controller 420 sends a control signal to the vehicle controller 460 to request a reduction in speed of the host vehicle to match that of the lead vehicle. The vehicle controller 460 is then operative to control the throttle mechanism 480 and/or the braking mechanism 470 in order to reduce the speed of the host vehicle. When the longitudinal controller 410 determines that the host vehicle speed matches that of the lead vehicle and that the desired following distance is maintained, the longitudinal controller 410 generates another control signal to couple to the vehicle controller 460 to request that the current speed be maintained.

The lane change controller 430 is operative to control a lane change action in response to a request for a lane change, global positioning system (GPS) data and high definition map data. If the lane change controller 430 receives a request for a lane change, the lane change, the lane change controller 430 retrieves the high definition map data from either the memory 455 or via wireless network through the antenna 435. T lane change controller 430 retrieves the GPS data via the antenna 435 or the memory 455. The lane change controller 430 first determines the optimal lane change time based on at least one of user input, vehicle speed, and geographical location. For example, the lane change controller may determine that the optimal lane change time is three seconds. The lane change controller 430 then determines an optimal path between the closest middle point on the current lane and a target point on the target lane that is the optimal lane change time away. lane change controller 430 then generates a control signal indicative of the optimal path to the vehicle controller 460. The vehicle controller 460 then generates a control signal to couple to the steering mechanism 490 in order to perform the lane change action. The lane change controller 430 is then operative to monitor the location of the host vehicle within the lanes. Once the host vehicle reaches target point, the lane change controller 430 then generates a first control signal to couple to the latitudinal controller 420 to request that latitudinal control be resumed by the latitudinal controller 420. The lane change controller 430 may further generate a second control signal to couple to the vehicle controller that the lane change operation has been completed and lateral control has been resumed by the latitudinal controller 420.

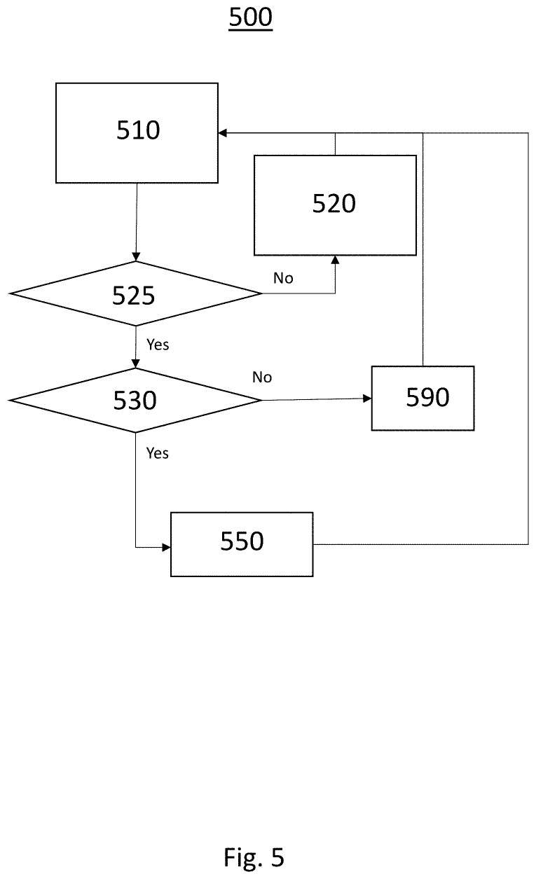

Turning now to FIG. 5, a flow chart illustrating an exemplary implementation of a system for high definition map based vehicle control for assisted driving 500 in a host vehicle is shown. The method is first operative to perform the longitudinal control 510 in the adaptive cruise control. The method then checks if a lane change is desired 525 in response to a determined host vehicle speed and a following distance to a lead vehicle. If no lane change is desired, the method is then operative to perform a lane keep algorithm 520 according to the adaptive cruise control to maintain host vehicle centering within the current lane. The method then returns to performing the longitudinal control 510.

If a lane change is desired 525, the method is then operative to determine if a lane is available to either the left or the right of the host vehicle. Lane availability is determined in response to location of proximate vehicles within the adjacent lanes. If no lane is available 530, the speed to the host vehicle is reduced in order to maintain a desired following distance with respect to the lead vehicle. If a lane is available 530, the method is then operative to execute the lane change action 550 to the available adjacent lane. When the host vehicle arrives in the center of the available adjacent lane, the method then returns to performing the longitudinal control 510.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a first processor for calculating a following distance in response to a radar data file and for generating a change lane request in response to the following distance being less than a threshold value;
a second processor for receiving the change lane request and for determining a lane availability in response to an image and the change lane request and for generating a lane change control signal in response to the lane availability;
a third processor for calculating a lane change route in response to a map data, and the lane change control signal;
a memory for storing an episode generated in response to the radar data, the lane change request, the lane change control signal and the lane change route; and
a vehicle controller executing a lane change in response to the episode.

2. The apparatus of claim 1 wherein the first processor is a longitudinal processor for maintaining the following distance in an adaptive cruise control system.

3. The apparatus of claim 1 wherein the second processor is a latitudinal processor for performing a lane centering operation in an adaptive cruise control system.

4. The apparatus of claim 1 wherein the third processor is a lane change processor for performing the lane change in an adaptive cruise control system.

5. The apparatus of claim 1 wherein the radar data file is generated in response to a vehicular adaptive cruise control data log.

6. The apparatus of claim 1 wherein the lane change is executed before the following distance reaches a minimum value.

7. The apparatus of claim 1 wherein the episode is generated in response to multiple lane change actions.

8. A vehicular control system comprising:
a memory for storing a lane change episode and a map data;
a radar sensor for detecting a distance to a lead vehicle;
a first processor for generating a lane change request in response to the distance;
a camera for generating an image of an adjacent lane;
a second processor for determining a lane availability in response to the image and for generating a lane change command in response to the lane availability;
a third processor for determining a lane change route in response to the lane change command, the episode, the map data and for generating a lane change control signal in response to the lane change route; and
a vehicle controller for executing the lane change in response to the lane change control signal.

9. The vehicular control system of claim 8 wherein the first processor is a longitudinal processor for maintaining the following distance in an adaptive cruise control system.

10. The vehicular control system of claim 8 wherein the second processor is a latitudinal processor for performing a lane centering operation in an adaptive cruise control system.

11. The vehicular control system of claim 8 wherein the third processor is a lane change processor for controlling the lane change in an adaptive cruise control system.

12. The vehicular control system of claim 8 wherein the vehicular control system is operative to perform an adaptive cruise control function in an assisted driving equipped vehicle.

13. The vehicular control system of claim 8 wherein the third processor is further operative to update the episode according to a reinforced learning algorithm.

14. A method for controlling a vehicle comprising:
determining a following distance between a host vehicle and a lead vehicle and a lead vehicle speed;
generating a lane change request in response to the following distance, a host vehicle speed and the lead vehicle speed;
determining an available lane in response to an image and the lane change request;
generating a lane change command in response to the available lane;
generating a control signal in response to the lane change request and a map data; and
controlling the vehicle to execute a lane change action in response to the control signal.

15. The method of claim 14 further comprising wherein the control signal is further generated in response to a global positioning system data.

16. The method of claim 14 wherein the host vehicle speed is reduced in response to the available lane indicating that a lane is not available.

17. The method of claim 14 wherein the following distance is determined in response to a radar signal.

18. The method of claim 14 wherein the image is generated by a side view camera mounted on the host vehicle.

19. The method of claim 14 wherein the control signal is generated in response to a lane change action episode and the map data.

20. The method of claim 14 further comprising updating a lane change episode in response to the control.
